(19) United States
(12) Patent Application Publication
(10) Pub. No.: US 2019/0343700 A1
(43) Pub. Date: Nov. 14, 2019

(54) MULTI-FUNCTIONAL THERAPEUTIC HOSPITAL BED CONVERTIBLE INTO A STANDING AID

(71) Applicant: Alexandr Urievich Ivanov, Obninsk (RU)

(72) Inventors: Alexandr Urievich Ivanov, Obninsk (RU); Urii Alexandrovich Belih, Obninsk (RU)

(21) Appl. No.: 16/472,209

(22) PCT Filed: Dec. 23, 2016
(86) PCT No.: PCT/RU2016/000921

§ 371 Date: Jun. 21, 2019

(51) Int. Cl. A61G 5/14; A61G 7/10; A61G 7/018

(52) U.S. Cl. CPC A61G 5/14; A61H 1/02; A61G 7/018; A61G 7/1015

(57) ABSTRACT

The invention relates to the field of medical technology, and more particularly to multi-functional hospital beds. The claimed structure comprises a vertical stand in the shape of an inverted L, which is connected to a folding bed. The bed has two sections, one of which can be folded onto the other, whereupon both sections can be folded to the vertical stand. A movable frame is disposed in the top corner of the stand, wherein said frame can be fastened in two positions: to the top part of the stand, and also at an angle of 45 degrees to the stand. A motor is provided, which pulls a cable. Said cable passes through the stand and the end of the movable frame. This provides two operating modes: Mode 1 is that of a bed. In this case, the frame is fastened to the stand, and the bed is unfolded. Traction or fixation can be applied to individual parts of a patient's body. Mode 2 is that of a standing aid. In this case, the bed is folded, and the frame is positioned at an angle of 45 degrees. The legs of the bed form a support, and the patient can be verticalized with the aid of the cable and a harness. The invention is simple and universal and is also capable of replacing several pieces of hospital equipment at once.

### FIELD OF INVENTION

The claimed invention relates to hospital devices used in rehabilitation treatment and for prevention of musculo-skeletal system diseases. More precisely, the claimed technical solution is a hospital bed, the elements of which provide the fixation and/or stretching and unloading of the whole body or its individual parts, and enable exercises performable in relaxed conditions, or facilitating a graduated exercise load in the initial lying, sitting, standing position. At the same time, such a bed is a multifunctional bed—with the use of standard fittings, it can be transformed into a standing aid—a device aimed at assisting a patient with limited motor abilities in taking a vertical position from a sitting position by a simple manipulation. Such a device can be installed both in hospital rooms and at home to continue the rehabilitation treatment after discharge from hospital. At the same time, it is worth noting that the claimed invention may be used in other areas of human activity. Thus, the device described below can be used in fitness centers for training or care for partially or completely immobilized people.

### PRIOR ART

The direct use of hospital bed elements for stretching or fixing individual parts of a patient's body has been known for quite some time and is a well-established practice today. Thus, it is difficult to imagine the trauma department of a modern hospital with no bed with a stretching and fixing device. Different models of such beds can also be used to transport patients or provide home care.

The prior art is, for example, a rehabilitation bed with electric control, disclosed in US patent claim US 2010113232 A1 (IPC A61F5/00; A63B21/00; A63B22/12; A63B26/00, publication date Feb. 1, 2011), the full text of which is integrated in the description as a link. This bed is electrically controlled and allows stretching a patient's upper and lower limbs and fixing them during post-traumatic rehabilitation. Despite easy control and efficiency, these hospital bed models are highly specialized. At the same time, the movement of such devices is significantly complicated by their weight, and their dimensions significantly limit their application. The structural complexity, low availability, strict staff requirements—all this virtually excludes such beds' use for home rehabilitation, for example, or in hospital wards of old buildings with a simple lack of space.

Another disadvantage is the high complexity of a patient's independent movements (for example, lifting or physical exercises), which significantly affects his/her morale. A long recovery process using such beds can lead to loss of strength, muscle atrophy and the occurrence of depression.

There are more complex and large-scale solutions, for example, the medical chamber disclosed in U.S. Pat. No. 5,456,655 A (IPC A61G12/00; A61G7/10; A61H3/00, published on Oct. 10, 1995), the full text of which is integrated in the description as a link. This document discloses a whole outpatient system, with a bed, special devices for patient lifting and moving and other similar purposes. However, the obvious complexity, huge weight and size, significantly limits the application of such solutions to a very large extent.

On the contrary, simpler technical solutions are known, for example, a mobile stretching device known from U.S. Pat. No. 4,236,265 A (IPC A61F5/04; A61H1/02, publication date Feb. 2, 1980), the full text of which is integrated in the description as a link. This document discloses a folding bed on wheels, the design of which allows for stretching and fixation of individual parts of a patient's body. However, this solution is intended for short-term transportation, which is why it does not provide for patient comfort. Thus, the use of this technical solution (or similar) does not seem possible for long-term rehabilitation.

A standing aid is another device known today. Such devices are designed to help patients with disabilities to rise from lying or sitting position.

An example of such devices is the patient seating position support system, disclosed in international claim WO 2016042704 A1 (IPC A61G5/00; A61G7/10; A61H1/02; B25J11/00; B25J13/00, published on Mar. 24, 2016), the full text of which is integrated in the description as a link. This document discloses a mobile device—the standing aid. According to the description, such a device can raise the patient to a standing position from a sitting position and vice versa.

Another example is the self-lifting device, disclosed in U.S. Pat. No. 4,566,094 A (IPC A61G5/14; A61G7/10, published on Feb. 11, 1986), or, for example, a movable standing aid from U.S. Pat. No. 4,809,997 A (IPC A61G5/02; A61G5/10; A61G5/14, publication date Mar. 7, 1989), or, for example, a device for sitting-to-standing position transfer, disclosed in international application WO 2016086238 A2 (CPC A61B5/11; A61G2005/128; A61G2203/32; A61G5/12; A61G5/14, publication date Feb. 6, 2016). However, all the described devices and appliances are highly specialized. The devices of this type can only provide standing aid function due to their high structural and manufacturing complexity and, consequently, low availability.

The use of soft supports is the most accessible and simple patient rising method, his/her propping and/or standing position fixation. An example of such a technical solution is disclosed in US patent application US 20160184151 A1 (IPC A61G5/14; A61G7/10, published on Jun. 30, 2016), the full text of which is integrated in the description as a link. This document discloses the use of a soft support method for lifting and fixing a patient in a standing position. Another example is a mobile device with a standing aid function, disclosed in US patent claim US 2016016645 A1 (IPC A61G5/14, published on Jun. 16, 2016), the full text of which is integrated in the description as a link.

However, despite all the advantages of the above devices, they have one serious drawback—all the described tools are specialized. Thus, if, for example, a hospital wishes to ensure the possibility of rehabilitating patients with various injuries, then it will have to have both types of devices separately—‘day beds’ and standing aids. This approach will require more space and will reduce the efficiency of its use and will require greater complexity in operation and maintenance, due to the use of a large number of different devices.

One of the solutions of this problem is the creation of universal devices that can be used simultaneously as a day bed with body parts fixing and stretching elements and as a standing aid. Another option is the use of devices that can be transformed into a standing aid from a bed with the use of simple manipulations and standard fittings.

The prior art describes the stretching installation, which can be applied both with scat and bed, disclosed in US patent U.S. Pat. No. 6,733,470 B1 (IPC A61H1/00; A61H1/02, publication date May 11, 2005), the full text of which is integrated in the description as a link. There are some flaws in the device despite the mobility and simplicity of design. Thus, according to this solution the suspension point is located on one and the same axis and in the case of pronounced trunk and limb asymmetry the imbalance cannot be levelled. There are no accessories for limbs and trunk fixation in the correct position. The patient cannot participate in the process as there are no supports or handrails—this brings additional discomfort as well as reducing motivation due to indifference, with all consequences. When the device is used in combination with a day bed, there are not enough body unloading points in the horizontal position.

The prior art device for lumbosacral spine stretching is disclosed in international claim U.S. Pat. No. 9,949,828 A1 (IPC A61H1/02, publication date Oct. 7, 1999), the full text of which is integrated in the description as a link. This technical solution has some drawbacks as well. Thus, the pulling force adjustment is possible only in one vertical plane. The device can be used as a standing aid by changing the day bed inclination angle, but the ability to perform complex movements of trunk and upper limbs, aimed at postural muscles strengthening is limited because of the bed being behind the back. This in turn limits the possibilities of using such a solution. There is no possibility of independent vertical positioning for people with lower paraparesis, when the arms and body are sufficiently active. The device is quite complicated in design.

Thus, the applicant is not aware of any effective means at present—a multifunctional device that could replace fully-fledged standing aids and beds for stretching, fixing or unloading in hospitals.

### SUMMARY OF THE INVENTION

The objective of the invention was to create a universal multifunctional means—a hospital bed, which could be transformed into a standing aid using standard fittings, while providing wide functionality in both “bed” and “standing aid” positions. The task of unifying the hospital means, simplifying their operation and maintenance has been consequently solved.

The present invention completely solves the problem. It is structurally simple, easily transformable into a standing aid and back again, using only standard fittings. The manipulation possibility in lying, sitting and standing positions is achieved with the use of this standing aid. The area around the folding device becomes free for medical gurneys and medical personnel passage. It is possible to use the claimed device in one of the modes to compensate for body weight and to perform therapeutic exercises in a suspended state to relieve pain and restore range of motion in the spine and joints. It is possible to compensate for a patient's body asymmetry and to create force with an asymmetric stretch and rotation effect due to bidirectional symmetric pulling force on the device sides and waist strap (binder) length adjustment on each side, which was difficult to achieve in many prior art devices. The C-shaped frame design of the present invention provides free access to work with the patient and allows to start training with weights in the early stages of a recovery period in combination with support struts (for example, a strut with lifting weights and adjustable pulling cable release height mechanism) on both sides of the exerciser at the wall. It is possible to choose exercises of different difficulty, changing from passive-active to active and strength exercises thanks to the combination of the unloading function, which can be facilitated by the presence of an electric lift, power struts and convertible day bed, which is especially important in cases of gross motor impairment. This standing aid can provide for the vertical positioning process of patients even with severe motor impairment. The applicable set of supports and locks allows fixing the patient starting from early recovery period.

All these advantages, as well as other technical results and improvements that will be described later, are achieved due to the fact that:

The medical exerciser includes a bed, a support strut with interconnected vertical and horizontal parts forming an inverted letter L, while the support strut is connected to the bed in the lower part, the lower part of the support strut incorporates an actuator with an attached end of flexible cable, stretched along the vertical part of the support strut, and:
the bed is made of movable sections so that they could be folded, and their sides facing the floor in the folded state could form a support, whose surface is parallel to the vertical part of the strut; a movable frame is installed in the junction of vertical and horizontal strut parts, so that it could be fixed in at least two extreme positions, in the first position the frame is fixed to the horizontal part of the strut, and in the second position the frame forms an angle from 30 to 60 degrees with the vertical part of the strut; the free end of the flexible pull cable is extended through the moving frame.
   Other embodiments are also possible in which:
   The bed is made of two movable sections so that the farthest section from the strut can be folded onto the nearest section so that their upper parts from the floor can come into contact, after which both sections can be folded to the strut.
   The flexible pull cable is extended through rings or rollers located at the vertical part of the support strut and the movable frame. The movable frame can be fixed in position when it becomes a bisector of angle between vertical and horizontal parts of the support strut.
   There are support elements and handrails on bed parts facing the floor so that they do not touch the floor when the bed is unfolded and at the same time they form support elements and handrails when the bed is folded.
   The flexible pull cable actuator is an electric motor. The actuator system additionally includes a load-counterweight. The flexible pull cable at its free end splits into at least two parts, at the end of each of them the fasteners are placed.
   A binder or elastic bands or suspensions are fixed to the flexible cable ends with fasteners to provide for individual body part fixation.

There are loops on the side of the bed sections facing the floor, to which patient fixation belts can be attached. The flexible pull cable is a rope.

The above features and advantages of the present invention, as well as means and methods for achieving them with the provision for the stated result will be more clear and understandable on the basis of further description of the invention embodiments with reference to the figures of drawings, in which:

### BRIEF DESCRIPTION OF DRAWINGS

FIG. 1—the first general schematic view of the present invention.

FIG. 2—the second general schematic view of the present invention.

FIG. 3—schematic view in bed mode.

FIG. 4—schematic view in standing aid mode.

FIG. 5—schematic view of force transfer system.

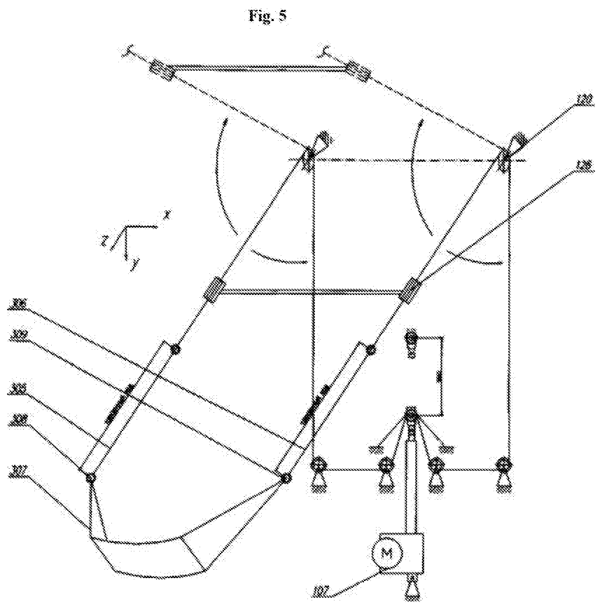

### INVENTION EMBODIMENTS

For the purposes of the present description, it is necessary to clarify a number of terms and definitions that are used throughout the text for clear understanding.

Terms “bunk”, “couch”, “bed”, “hospital bed”, “medical bed”, “therapy table”, “kinesitherapic table” and the like should be understood in the present description as medical bed, i.e., the bed used for patient placement for further treatment.

Term “standing aid” should be understood in the present description as an independent device or a device complementing another device to bring a patient's body to an upright position in order to prevent and treat alleviation of negative physiological and psychological consequences of prolonged sitting and lying positions (pulmonary and renal failure, pressure sores, osteoporosis, depression). The standing aid may be applied, but not limited, to impaired motor functions due to spinal cord, spinal medulla and brain injuries; joints and spine after surgery; post-stroke conditions and other diseases accompanied by limited motor abilities.

The term “stretching” or “extension” in the present description is synonymous with the term “traction” and shall be understood in the following sense. Traction (extension) is a set of methods for prolonged stretching of limbs or muscles in orthopedic medicine. It may be used as a treatment method, for example, but not limited to fractures, as well as in the treatment of the spinal cord (spine traction).

The term “post-traumatic rehabilitation”, which in some parts of the description can be used simply as “rehabilitation” shall be understood as an integrated and prolonged patient recovery process after injuries, including those leading to complete or partial immobilization. Such a process may include the creation of a comfortable environment for a patient (but this condition is not mandatory) with fixation or extension of individual body parts. This process may also include a set of measures aimed at maintaining physical fitness, combating muscle atrophy and maintaining a patient's mental state, as well as other measures.

The term “binder” or “tractional binder” is understood for the purposes of the present description as a large strip of fabric or ductile material (or any another material with similar properties) to achieve the desired stretching (pulling force). Such a binder can be of a certain shape, may be applied with the consideration of individual patient characteristics and it may be reusable or expendable.

The term “power scheme” or “power frame” or “power rack” should be understood in the present description as a rigid structure made of high-duty materials, such as steel or aluminium. Such a frame provides changes in force application direction and usually (but not necessarily) may include one or more moving units for force transmission from electric motor or power column. Such a frame is combined with the bed frame or standing aid directly.

The term “flexible pull cable” or “pull cable” in the present description is understood as a flexible element, such as, for example, but not limited to, a flexible cable, rope or tensile (e.g., stitched or reinforced) flexible band, by which and with the use of transmitting elements it is possible to transmit the force from the electric motor to the desired point.

The term “force transmitting clement” is understood as a flexible transmission clement, which allows changing force direction. Such an element is, for example, a movable or fixed unit, which is rotatable. Another option may be a roller with the possibility of rotation. It is possible to use simple loops through which a flexible pull cable passes. Other embodiments of such elements are known in the art, equivalent in function to the described units or rollers.

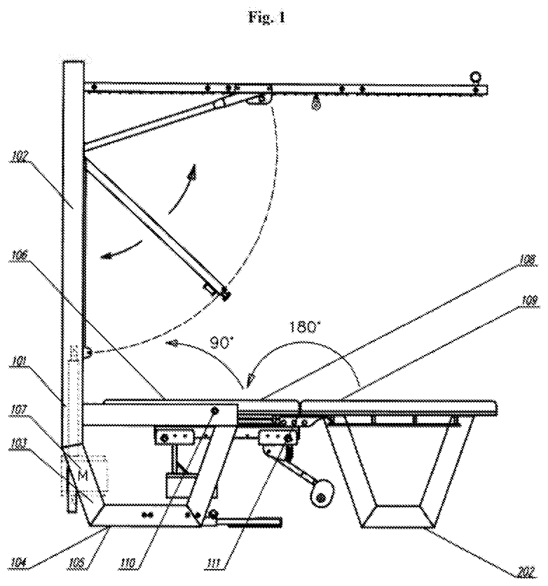

The present invention represents the following structure (FIG. 1). The basis is the bearing frame (101) which, preferably, is a vertical strut (102) with a base (104). Such a strut may be attached to a room wall where the device is planned to be operated. The lower part (103) of the bearing frame (101) is at the same time both the base (104) of support strut (102) and one of the bed (106) supports (105). The electric motor (107) is preferably located in strut (102) base area (104). Additionally, the bearing frame (101) can also be used for electrical communications branching, flexible or other transmissions, power supply and control elements.

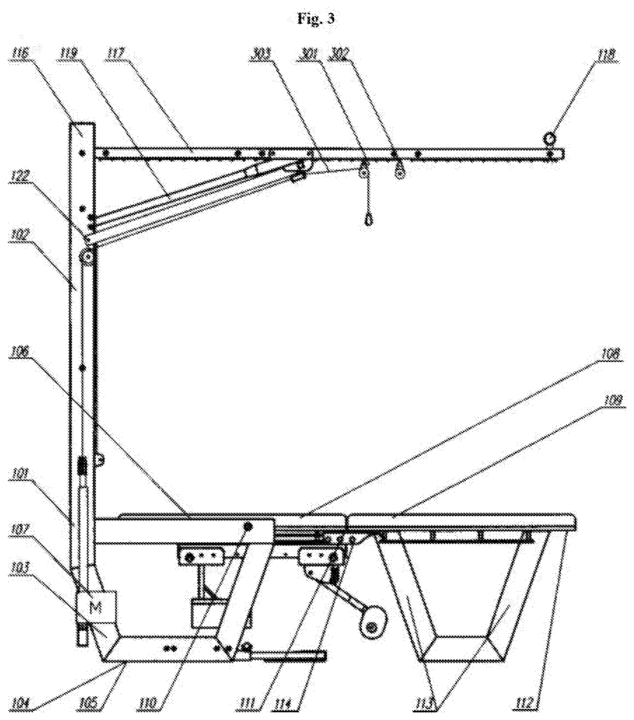

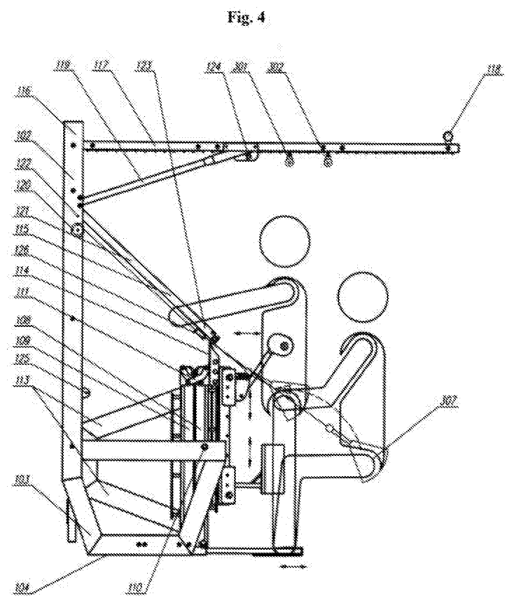

The bed (106) has a complex structure. In addition to the first support (105) formed by part (104) of the support strut (102), it includes at least two moving parts—the first (108) and the second (109). The first part (108) is connected to support (105) by the first joint (110), for example, a hinged one, which allows part (108) to rotate relative to support (105). The second part (109) of bed (106) is connected to the first part (108) by means of the second joint (111), which is a hinge, for example, and also allows the second part (109) to turn in relation to the first part (108). Thus, there are at least two extreme positions of the bed's moving parts. The first (FIG. 3) forms the bed proper on which the patient can lie horizontally. In this case, the second part of the bed (109) forms one straight line with the first part (108), and such a straight line is perpendicular to the vertical strut (102). As a result, the device takes the form of a medical bed. The second extreme position of the bed elements forms a standing aid (FIG. 4). In this case, the second part of the bed (109) folds onto the first part (108), which, in turn, is fixed on the strut (102).

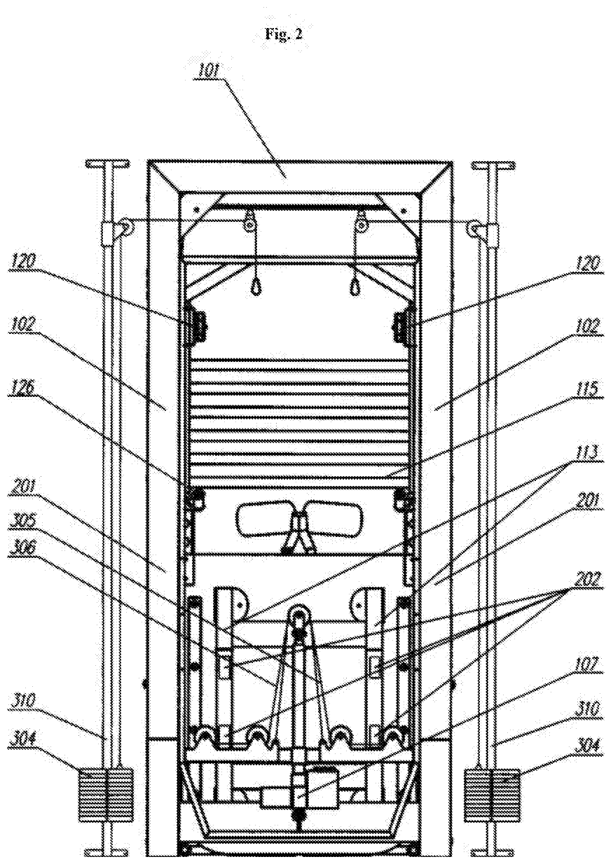

On conditionally a bottom (“top” and “bottom” are defined by FIG. 3) surface (112) of the second part (109) of the bed (106) the supports (113) are located. Preferably they are legs and, preferentially, with four support points. The supports (113) are preferably designed in such a way that in the standing aid position, they will not rest against the support strut elements (102). This can be implemented, for instance, as follows (FIG. 2). The support strut (102) consists of several vertical columns (201), preferably two. Then, supports (113) may be of four legs (202) and in standing aid position they will be between columns (201). There is a stopper (114) and handrail (115) on the conditionally lower surface of the first part (108) of the bed (106). Moreover, their location is such that in the standing aid position (FIG. 4), the stopper (114) forms the standing aid support and the handrail (115) forms the standing aid handrail, which is designed to help patients to rise independently or semi-independently. In this case, the handrail (115) is designed in such a way that it can change its inclination angle relative to the surface of the first part (108) of the bed (106).

Generalizing the description of the bed structure (106) it can be summarized that the bed (106) is made with the possibility of transformation by simple manipulations with standard fittings (including connections (110, III), as well as fixing devices, not shown conventionally in the figures of drawings) into the standing aid support clement (FIG. 4).

The vertical support strut (102) in its upper part (116) is connected to the horizontal frame (117), which, in one of the invention embodiments can be made with a possibility of inclination angle variation relative to strut (102). The frame (117) preferably has a loop (118) (or similar function element) at its far end from the attachment place to strut (102) with which the holding cable can be used (not shown conventionally). In this case, the second end of such a cable may be fixed to the room wall or ceiling. The strut (102) also has, preferably, an additional supporting element (119) located at an angle relative to the strut itself (102) in such a way that the end of the strut (116), as well as the additional supporting element (119), form a triangular angular frame (117) mount. Several fixed rollers (301, 302) or, in another embodiment, movable rollers (301, 302), but with the possibility of their subsequent fixation in certain positions, can be mounted on a plate (117). A force transmitting clement (120), such as, for example, a fixed unit is also installed in the area of additional supporting element (119) connection and the vertical support strut (102).

A rotating frame (121) is installed in the upper part of the vertical strut (102) with fastener (122). The frame is, preferably, installed in an additional supporting element (119) attachment area to the vertical support strut (102) and location of the force transmitting clement (120). Any type of attachment (122) can be used, for example, a hinged mount. The plate (121) fastening mechanism (122) provides the ability to change the plate (121) position between at least three extreme positions. The first of these positions is when the end (123) of frame (121) not fixed to the strut (102), which is fastened with the fastening element (124) on the additional supporting element (119). The second of these positions is when end (123) is fixed at the strut (102) surface with the fastening element (125). The third position is when the frame is in an intermediate position between the first and second positions described above with the use of the rotation mechanism (122) lock, In the latter case, the preferred frame (121) inclination angle relative to the vertical column (102) equals 45 degrees, if the second of the above possible frame (121) positions is taken as zero degree. There is a transmitting element (126), preferably a slide sleeve in the end area (123) of the frame (121).

Important parts of the present invention are pulling cables, binder, as well as flexible transmission rods. From (FIG. 3) the electric motor (107) using transmitting elements (for example, fixed blocks) (120, 126), and also, in the bed position, using transmitting elements (301, 302) with flexible cable (303) through which the force is transmitted. It is also preferable to use a load (304), which can be a massive block mounted on guides (310) parallel to the strut (102) to improve performance and reduce the load on the electric motor (107) with the ability to move in a vertical plane along the axis of the strut (102).

In one embodiment, the end portion of the pull cable (303) may be split into two cables. In another, preferred, embodiment, the pull cable (303) consists of two independent flexible elements (305, 306), which can move both synchronously and asynchronously and pass through the same transmitting elements (120, 126, 301, 302).

An important element of the invention is that the binder (307) be made from flexible, but durable (reinforced or stitched) fabric, for example. Two opposite sides (308, 309) of such a binder are connected to the ends of two flexible cables (305, 306). Such connections are preferably made detachable. Thus, it is possible to transfer force from the electric motor (107) to the binder (307) by a flexible cable (303), which is divided into two elements (305, 306), as well as a set of force transfer elements (120, 126, 301, 302). It is important to note the application of force to the binder (307) at two (or more) points. In this case, it is possible to transfer the forces of complex directions with non-trivial moments relative to the central binder point (107) with the use of a binder with asynchronous movement of elements (305, 306).

Let us consider the use of the invention in the preferred embodiment.

Various therapeutic methods may be applied in the exerciser. One of them is a therapeutic method to restore normal motor patterns using high level neuromuscular stimulation. This is an active curative approach that uses five key elements:

1. The exercises are performed in a horizontal and vertical position of the patient propped against an unstable support, when a part of the body rests on the suspension with no support upon the bed. Such exercises can be performed both with hanging out with the use of electric motor, and hanging out of separate parts, using auxiliary weights and/or elastic elements;

2. In a similar way it is possible to remove (compensate) the gravitational effect on individual muscles or groups of muscles by hanging out the whole body or body parts. It also allows to perform movements without overcoming the limb weight, as well as to create the effect of slight spine and joints stretching;

3. It is possible to use weights (loads and/or elastic elements) of calibrated value in reduced gravitational action for a planned and controlled load increase when performing exercises.

4. It is possible to limit or completely relieve the effects on certain body areas by fixation in both horizontal and vertical body positions and adding the load on non-fixed muscle groups.

5. The vertical positioning is aimed at restoring the postural-tonic and dynamic activity of postural and vestibular reflexes. It stimulates and maintains orthostatic reactions, reflex mechanisms of anorectal expulsion and urinary bladder emptying, and improves respiratory function;

The use of the exerciser also involves testing procedures that evaluate the neuromuscular function of kinetic chains with an emphasis on integrating the function of “local” and “global” muscles. For example: a test for neutral position holding time to check the “local” muscles function; a test to identify weak kinetic chains and the disruption of their interaction.

It is possible to carry out manual correction using dynamic mobilization/manipulation techniques (tractional, rotational, flexural, extensional, lateroflexional, ventrodorsal, lateral) by fixation and unloading in different initial positions in the cervical, thoracic, lumbar, sacrococcygeal regions of vertebral column, postisometric relaxation and myofascial muscles release.

It is possible to put the patient in an isometric body weight holding position with manual pulsation or controlled vibration from external vibration devices. The workload and instability degree can gradually increase during exercises from the weakest to the most complex. Thus, the exercises can be used in groups of patients from the lowest functional status to trained athletes.

Thus, the following effects may be achieved:

1. Restoration of the correct sequence of muscular tension, fixation of new motor patterns;

2. Restoration/compensation of disturbed functions with activation of individual body reserves;

3. Normalization of active movements' amplitude and accuracy;

4. Improvement of motor actions sensory support (visual, verbal, tactile control);

5. Restoration of vertical position static patterns;

6. Balance exercise in a vertical position;

7. Cardiovascular system improvement;

8. Stimulation of intestinal and urinary bladder activity;

9. Improvement of respiratory system functions;

10. Prevention of contractures;

11. Improvement of psycho-emotional condition;

12. Increased tolerance to physical activity;

13. Prevention of osteoporosis.

And other effects as well.

About the exerciser in the unfolded position (“bed” position); In this position, the supports (113) constitute four legs (202); the bed elements (108, 109) represent a ‘monolithic’ structure—a bed (106). The rotary frame (121) is in a position perpendicular to the support strut (102). The roller (301) provides for force transmission in an upward direction relative to the bed surface (106).

Physical exercises, unloading or stretching exercises are performed by placing the patient on the horizontal bed surface (106) in the lying or sitting position. A binder (307) can be used for manipulations, although equivalent elements may also be used, for example, simple fixation of the pull cable (303) or elastic cables fixation (not conventionally shown in the drawings) at the end section (303) or its elements (305, 306). Another option would be to replace the binder (307) with suspensions for separate body parts. In one embodiment, such suspensions may be structurally similar to the binder (307). The following is a non-limiting (not complete) list of possible manipulations.

Body parts or the whole body fixation on suspensions of an off-loading module (117) in the raised position above table surface (static cables);

Fixation of body parts on suspensions with elastic cables;

Body parts or the whole body fixation on suspensions with a cable sliding through the block;

Exercises with non-balanced weighting of block exerciser (for example, in combination with off-loading module or separately);

Fixing the limbs with special bands on the guide at table underside;

The primary nodes preferably operate in “bed” mode as follows.

1. The method of performing exercises on unstable supports is based on the use of loads for maintaining body weight under the load of biomechanical chains. This is a therapeutic method that uses a high level of neuromuscular stimulation to restore normal functional movement patterns.

2. Performing exercises on the “block-roller” increases the instability of the support and extends the range of possible movements. It is possible to create spiral-diagonal movements, coactivating (coactivation or contraction—the contraction occurs both in agonists and antagonists) “local” and “global” muscles in response to performing exercises under body weight and cable sliding through a block. It helps to increase the freedom of motion range in the joints, and stabilizes the spine and the joints.

3. Exercising with the use of elastic cables fixed on the discharge module helps the patient to master flexion, extension, circular and vortical movements in the limbs and trunk under lightweight conditions. Such exercises contribute to improvement of tactile and proprioceptive input of sensory irritation in the case of movement disorders, and also to improve the mutual spatial body part sensing. The ability to move the suspension points at different angles allows creating an adjustable force aimed at weight compensation at any point of the bed area.

4. The combination of the unloading module and the power column provides the possibility of transition from lightened movement conditions to exercises with weights. Such combination provides an integrated approach to individual rehabilitation program, increases the variability of possible exercises and continuity in physical therapy methods application at different recovery stages. The ability to control the power column cable direction, a small step weight variation (preferably from 1.0 to 30 kg) makes it easy to adapt the exercise to individual abilities of each patient.

5. Body part fixation in a predetermined position with special straps allows securely fixing the limb in the correct position. The method is used for treatment by the correct position in case of spastic pareses, or contractures development. Additional opportunities for muscles, tendons and ligaments stretching in different initial positions.

Let us consider some possible exercises.

In the initial position (hereinafter—LP.)—lying on the back, one leg bent at hip and knee joints, the other one on the bed in a deflexion position. The suspension points are located above hip and ankle joints. Ankle damper tension—vertical. Femoral damper tension—the suspension point shifts in the cranial direction along the leg axis, the tension force depends on what is to be obtained—resistance or relief.

Movement: flexion and extension in the knee and hip joints.

I.P. lying on stomach, the hip joint is extended, the knee is bent. A cuff with a metal ring at the end is fixed on the lower part of the surae. In the case of severe weakness of thigh muscles for independent leg extension, the suspension point is placed vertically above the knee joint flexion axis, the damper is slightly tensioned, and the patient tries to unbend the leg with a swinging motion (visual control through side mirror is desirable). The power module, block position and load are selected individually to resist bending/unbending.

I.P. Lying on back. The legs are unbent at hip and knee joint, one leg is raised at 45 degrees above the bed plane. Arms are along the body, palms down.

Additional equipment: surae cuff, elastic cable.

Movement: straight leg down.

Recommendations: inhale in the initial position and exhale at the highest tension phase. Ensure that no additional tension is created in other body parts. The suspension point moves in the cranial direction when the resistance is to be created. The power module may be used.

Exerciser in unfolded position (“standing aid” position). In this position, the rotary mechanism (122) is locked; the rotary frame (121) is in the intermediate position. The bed (106) is in the folded state, that is, the second part of the bed (109) folds onto the first part (108), which, in turn, is fixed on the strut (102). In the preferred embodiment of the support strut (102), the four legs (202) are in the described mode, in the gaps between columns (201). The stopper (114) and the handrail (115) occupy the corresponding position (FIG. 4) and become parts of the standing aid.

The exerciser in the folded position allows, among other things, to bring the patient to the vertical position with the aim to train orthostatic stability and maintain the maximum mobility level against gravity. The afferentation from articular and muscular-articular receptors is enhanced due to joints and spine closure, which stimulates the functioning of the cerebellum and the vestibular apparatus. The arising senses make it possible to consciously coordinate movements and control the body position in an upright position.

In the preferred embodiment, the module is equipped with all the necessary adjustments, handrails and latches, which allow adjusting the device to individual peculiarities of the person, performing trunk and upper limbs movements in a natural standing position.

It is possible to reduce hyperlordosis of the lumbar spine, and excessive abdominal bulging due to support height and depth adjustment for body front, which, combined with compression stockings and an abdominal binder, reduces excessive blood deposition in the abdominal cavity and lower limb vessels and also facilitates diaphragmatic flutter and its displacement into chest cavity in the expiratory phase. This is especially important for patients with tetraplegia and paraplegia above the Th6 level (6^{th} thoracic vertebra) since orthostatic hypotension is the most common manifestation in acute and early recovery period at the upright position for this category of patients.

Adjustable feet-holders ensure reliable fixation of the feet in the correct position.

It is possible to use the power and discharge module when performing exercises in the standing position. Thus, the device allows performing the following exercises among others in the “standing aid” mode.

I.P. Standing in a standing aid. One hand holds the standing aid handrail and the other straight arm is lowered along the body and holds the elastic cable or power column cable.

Movement: one arm up against the elastic cable resistance or power column load. Simultaneously with arm upward movement, the trunk leans towards the supporting arm. The active arm shall remain straight. In the initial position—inhalation, in the maximum arm abduction phase—exhalation.

The multifunctionality of the exerciser allows simultaneous using of several types of effects in one exercise. For example, the distal part of the limb may be fixed in a raised position above a table surface (discharge module) and the proximal part shall be connected with an elastic damper or power column with lightening/weighting action, depending on the exercise purpose. This allows performing movements without overcoming the limb weight. And also to create conditions for performance of movements in a strictly assigned direction. The simultaneous use of horizontal surface (kinesitherapic table), unloading module, power module, and elastic cables significantly increases the variability of possible impacts.

One or several limbs are suspended with the help of loops/cuffs at the beginning of exercises with the use of a discharge module and elastic cables. As a result, it becomes possible to virtually neutralize the effect of gravity on the motion. For example, “hanging” the leg by foot and thigh the load on the hip and knee joints reduces. Elastic dampers can be used both for limbs unloading and for weighting during active movements. An unstable support can be created with the use of cables and suspensions to enhance active segmental stability by joint contraction of “local” and “global” muscles.

Thus, the above described implementation examples and methods of using the claimed technical solution show that the present invention is a universal device that is able to easily replace many individual complex hospital devices. Also, the claimed device is structurally simple, and, therefore reliable. The design of the claimed solution has great potential for modernization and use, and the combination of structural elements, as well as compatibility with many existing medical devices, allowing for a wide range of rehabilitation and therapeutic exercises.

All this shows that the claimed invention can be implemented on the basis of the presented description with achievement of the claimed technical result. At the same time, the examples described above are not exhaustive. Other ways of implementing and applying the present invention in the framework of the formula at a practical technological level could become obvious to a specialist.

### INDUSTRIAL APPLICABILITY

The present invention can be easily implemented on an industrial scale with the context of current technological development. Thus, there are no obvious problems in the manufacture of individual power elements of the structure, their transportation and assembly, including assembly at the place of intended use. The manufacture of moving elements of the described device, as well as their connections, is also a trivial task for modern industry. Electronic equipment, including controls, as well as electrical safety, such as those used in the present invention, are repeatedly described in various sources of information included in the prior art. Thus, the task of bringing the claimed invention to industrial production will obviously fall into the class of overcoming the usual engineering difficulties typical of such procedures for a specialist. The invention and development of new, not previously known means and methods for the industrial implementation of the claimed invention will not be required.

1. The medical exerciser includes a bed, a support strut with interconnected vertical and horizontal parts forming an inverted letter L, while the support strut is connected to the bed in the lower part, the lower part of the support strut incorporates an actuator with an attached end of flexible cable, stretched along the vertical part of the support strut, and:
the bed is made of movable sections so that they could be folded, and their sides facing the floor in the folded state could form a support, which surface is parallel to the vertical part of the strut; a movable frame is installed in the junction of vertical and horizontal strut parts, so that it could be fixed in at least two extreme positions, in the first position the frame is fixed to the horizontal part of the strut, and in the second position the frame forms a 30 to 60 degrees angle with the vertical part of the strut; the free end of the flexible pull cable is extended through the moving frame.

2. The medical exerciser according to claim 1, wherein the bed is made of two movable sections so that the farthest section from the strut can be folded onto the next section so that their upper parts from the floor come into contact, after which both sections can be folded to the strut.

3. The medical exerciser according to claim 1, wherein the flexible cable is extended through rings or rollers located at the vertical part of the support strut and the movable frame.

4. The medical exerciser according to claim 1, wherein the movable frame can be fixed in position when it is the bisector of the angle between vertical and horizontal parts of the support strut.

5. The medical exerciser according to claim I, wherein there are support elements and handrails on bed parts facing the floor so that they do not touch the floor when the bed is folded and at the same time form support elements and handrails when the bed is folded.

6. The medical exerciser according to claim 1, wherein the flexible cable actuator is an electric motor.

7. The medical exerciser according to claim 6, wherein the actuator system additionally includes a load-counterweight.

8. The medical exerciser according to claim 1, wherein the flexible cable at its free end splits into at least two parts and the fasteners are placed at the end of each.

9. The medical exerciser according to claim 8, wherein a binder or elastic straps or suspensions are fixed to the flexible cable ends with fasteners to provide for individual body parts fixation.

10. The medical exerciser according to claim 1, wherein there are loops on the bed sections side facing the floor, to which patient fixation straps can be attached.

11. The medical exerciser according to claim 1, wherein the flexible cable is a rope.
